(19) United States
(12) Patent Application Publication
(10) Pub. No.: US 2012/0051504 A1
(43) Pub. Date: Mar. 1, 2012

(54) RADIATION IMAGE CAPTURING APPARATUS, RADIATION IMAGE CAPTURING METHOD AND RADIATION IMAGE CAPTURING PROGRAM STORAGE MEDIUM

(75) Inventors: Yasunori OHTA, Ashigarakami-gun (JP); Yusuke KITAGAWA, Ashigarakami-gun (JP); Tetsuro KUSUNOKI, Ashigarakami-gun (JP); Naoyuki NISHINO, Ashigarakami-gun (JP); Noriaki IDA, Ashigarakami-gun (JP); Takeshi KAMIYA, Ashigarakami-gun (JP)

(73) Assignee: FUJIFILM CORPORATION, Tokyo (JP)

(21) Appl. No.: 13/220,801

(22) Filed: Aug. 30, 2011

(30) Foreign Application Priority Data
Aug. 31, 2010 (JP) 2010-194395

(51) Int. Cl. H05G 1/52; H05G 1/64

(52) U.S. Cl. 378/41; 378/98

(57) ABSTRACT

Disclosed is a radiation image capturing apparatus including a storage unit that stores imaging site information associated with default image capturing angle information about a radiation image to be captured first among a plurality of radiation images of an object captured from different angles with a radiation ray emitted from a radiation source; a radiation source holding unit that holds the radiation source, with an angle of the radiation source being variable; a display unit that displays the default image capturing angle information associated with the imaging site information, the default image capturing angle information being displayed as initial image capturing angle information and variable information; a receiving unit that receives change information about the initial image capturing angle information; and a control unit that controls the radiation source holding unit to change the angle of the radiation source, based on the change information received by the receiving unit.

### CROSS-REFERENCE TO RELATED APPLICATION

This application claims priority under 35 USC 119 from Japanese Patent Application No. 2010-194395 filed on Aug. 31, 2010, the disclosure of which is incorporated by reference herein.

### BACKGROUND OF THE INVENTION

1. Field of the Invention

The present invention relates to a radiation image capturing apparatus, a radiation image capturing method and a storage medium, and more particularly, to a radiation image capturing apparatus and a radiation image capturing method for capturing radiation images for stereoscopic viewing, and a storage medium.

2. Related Art

Japanese Patent Application Laid-Open (JP-A) No. 2008-253762 discloses a portable radiation image capturing apparatus that is not permanently installed in a medical clinic or hospital or the like, but is used at home, for example.

In a portable radiation image capturing apparatus that is not permanently installed in a medical clinic or hospital or the like but is used at home, easy setting of image capturing conditions is desired.

A main object of the invention is to provide a radiation image capturing apparatus that captures plural radiation images for stereoscopic viewing, and may allow easy setting of image capturing conditions. The invention is also to provide a radiation image capturing method and a storage medium.

### SUMMARY

According to a first aspect of the present invention, there is provided a radiation image capturing apparatus comprising:

a storage unit that stores imaging site information associated with default image capturing angle information about a radiation image to be captured first among a plurality of radiation images of an object captured from different angles with a radiation ray emitted from a radiation source;

a radiation source holding unit that holds the radiation source, with an angle of the radiation source being variable;

a display unit that displays the default image capturing angle information associated with the imaging site information, the default image capturing angle information being displayed as initial image capturing angle information and variable information;

a receiving unit that receives change information about the initial image capturing angle information; and

a control unit that controls the radiation source holding unit to change the angle of the radiation source, based on the change information received by the receiving unit.

According to a second aspect of the present invention, there is provided a radiation image capturing method comprising:

causing a display unit to display default image capturing angle information as initial image capturing angle information associated with imaging site information, the default image capturing angle information being about a radiation image to be captured first among a plurality of radiation images of an object captured from different angles with a radiation ray emitted from a radiation source, the imaging site information and the default image capturing angle information being associated with each other and being stored in a storage unit; and

controlling a radiation source holding unit to change an angle of a radiation source, based on change information received by a receiving unit that receives the change information about the initial image capturing angle information, the radiation source holding unit holding the radiation source, with an angle of the radiation source being variable.

According to a third aspect of the present invention, there is provided a non-transitory computer-readable medium storing a program that causes a computer to perform a process including:

causing a display unit to display default image capturing angle information as initial image capturing angle information associated with imaging site information, the default image capturing angle information being about a radiation image to be captured first among a plurality of radiation images of an object captured from different angles with a radiation ray emitted from a radiation source, the imaging site information and the default image capturing angle information being associated with each other and being stored in a storage unit; and

controlling a radiation source holding unit to change an angle of a radiation source, based on change information received by a receiving unit that receives the change information about the initial image capturing angle information, the radiation source holding unit holding the radiation source, with an angle of the radiation source being variable.

### BRIEF DESCRIPTION OF THE DRAWINGS

Exemplary embodiments of the present invention will be described in detail based on the following figures, wherein:

FIG. 1 is a schematic view for explaining a radiation image capturing apparatus according to a preferred exemplary embodiment of the invention;

FIG. 2 is a schematic block diagram for explaining the radiation image capturing apparatus according to the preferred exemplary embodiment of the invention;

FIG. 3 is a perspective view for explaining the structure of a stereo display device of the radiation image capturing apparatus according to the preferred exemplary embodiment of the invention;

FIG. 4 is a diagram for explaining a case in which an image on the stereo display device of the radiation image capturing apparatus is stereoscopically viewed according to the preferred exemplary embodiment of the invention;

FIG. 5 is a schematic view for explaining stereo image capturing using the radiation image capturing apparatus according to the preferred exemplary embodiment of the invention;

FIG. 6 is a schematic view for explaining stereo image capturing using the radiation image capturing apparatus according to the preferred exemplary embodiment of the invention;

FIG. 7 is a flowchart for explaining stereo image capturing method using the radiation image capturing apparatus according to the preferred exemplary embodiment of the invention; and

FIG. 8 is a table showing the imaging sites used by the radiation image capturing apparatus according to the preferred exemplary embodiment of the invention, the initial angles for the first image capturing operation, and the displacement angles of the radiation source between the first image capturing operation and the second image capturing operation.

### DETAILED DESCRIPTION

The following is a description of a preferred exemplary embodiment of the invention, with reference to the accompanying drawings.

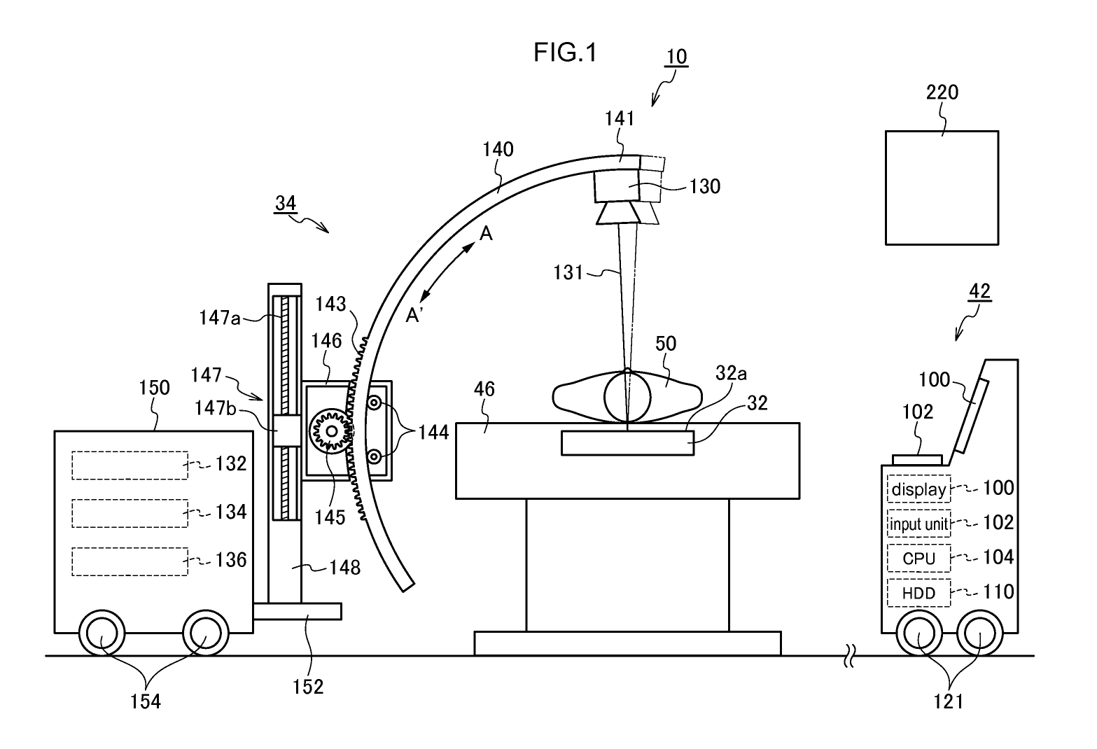

Referring to FIG. 1, a radiation image capturing apparatus 10 of the preferred exemplary embodiment of the invention includes a radiation generator 34, a console 42, a portable radiation image detecting device (hereinafter referred to as the “electronic cassette”) 32, and a stereo display device 220.

The electronic cassette 32 is positioned at a distance from a radiation source 130 of the radiation generator 34 that generates a radiation ray such as an X-ray when a radiation image is captured. In this exemplary embodiment, the electronic cassette 32 is horizontally positioned below an object 50 lying on his/her back on a bed 46, with a distance being kept between the electronic cassette 32 and the object 50. The object 50 is located between the radiation source 130 of the radiation generator 34 and the electronic cassette 32. When a radiation image capturing instruction is issued from the console 42, the radiation source 130 emits an X-ray 131 of a radiation level in accordance with predetermined imaging conditions and the like. The X-ray 131 emitted from the radiation source 130 carries image information after transmitted through the object 50, and then reaches the electronic cassette 32.

The radiation generator 34 includes a main body 150 and a C-shaped arm 140. The radiation source 130 that emits the X-ray 131 is attached to one end 141 of the C-shaped arm 140.

The C-shaped arm 140 is provided to penetrate through a box 146. A gear 143 is formed on an outer circumferential surface of a cylindrical face of the C-shaped arm 140. Rollers 144 attached to the box 146 are in contact with an inner circumferential surface of the cylindrical surface of the C-shaped arm 140. A gear 145 attached to the box 146 meshes with the gear 143 of the C-shaped arm 140. As the gear 145 is rotated by a motor (not shown), the C-shaped arm 140 rotationally moves in a clockwise direction A and a counterclockwise direction A′ shown in the drawing. With this arrangement, the radiation source 130 attached to the C-shaped arm 140 rotationally moves in the clockwise direction A and the counterclockwise direction A′.

As the radiation source 130 is rotated in the above manner, the radiation source 130 may be located in plural positions with parallaxes.

With this arrangement, one of plural images captured in different positions with parallaxes is visually recognized by the right eye, and the other one of the images is visually recognized by the left eye. In this manner, an image may be stereoscopically viewed.

A nut 147b of a ball screw 147 is attached to the box 146. A screw shaft 147a of the ball screw 147 is attached to a support pillar 148. As the screw shaft 147a is rotated by a motor (not shown), the nut 147b, the box 146, and the C-shaped arm 140 move up and down. By moving the C-shaped arm 140 up and down, the height of the center of rotation of the C-shaped arm 140 may be varied. The lower end of the support pillar 148 is attached onto a pillar supporting member 152 that horizontally protrudes from near a lower end portion of the housing of the main body 150.

Wheels 154 are attached to the bottom of the main body 150, so that the radiation generator 34 may move around. Wheels 121 are attached to the bottom of the console 42, so that the console 42 may move around. Therefore, the radiation image capturing apparatus 10 is configured as a portable apparatus which may be moved as a whole, and the apparatus 10 can be preferably used at home or the like.

The main body 150 contains a communication interface unit 132, a source control unit 134, and a source drive control unit 136 that are described later.

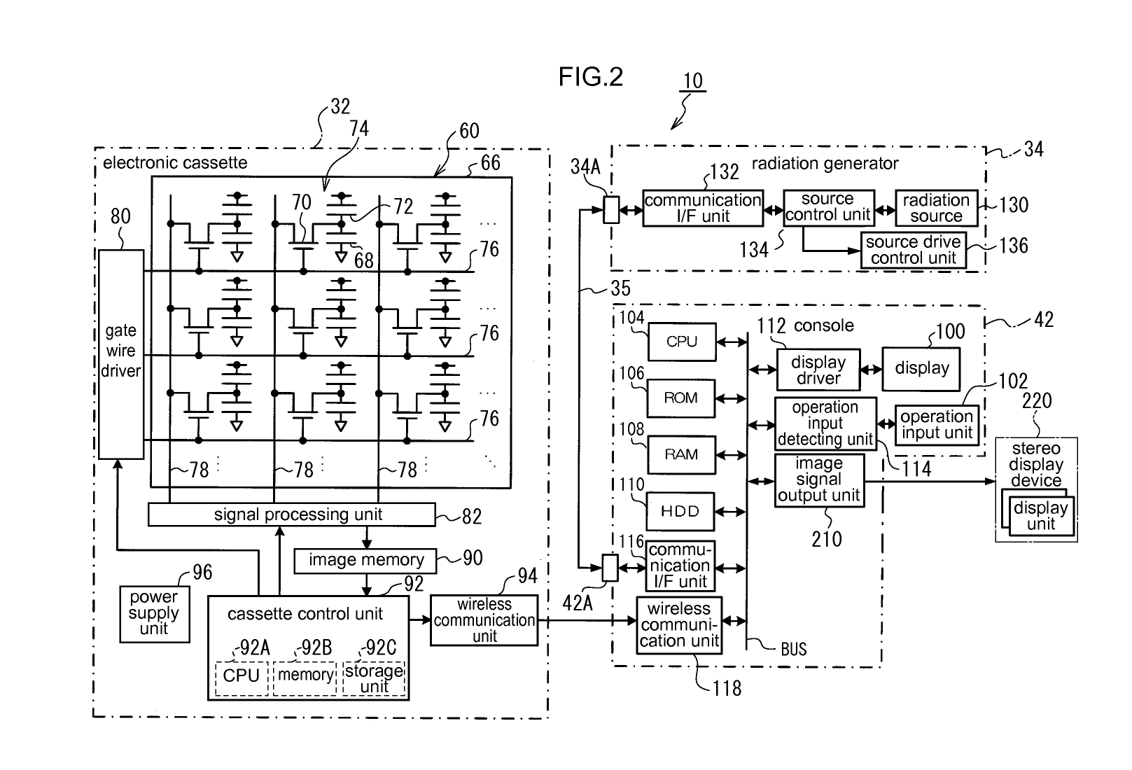

FIG. 2 is a block diagram showing the structure of the radiation image capturing apparatus 10 according to this exemplary embodiment.

The radiation generator 34 has a connecting terminal 34A for performing communication with the console 42. The console 42 has a connecting terminal 42A for performing communication with the radiation generator 34. The radiation generator 34 is connected to the console 42 via a communication cable 35.

A radiation detector 60 installed in the electronic cassette 32 is formed by stacking a photoelectric conversion layer on a TFT active-matrix substrate 66. The photoelectric conversion layer absorbs a radiation ray and convert the radiation ray into charges. The photoelectric conversion layer is made of amorphous selenium (a-Se) containing selenium as a main component (the content rate being 50% or higher, for example). When a radiation ray is applied to the photoelectric conversion layer, charges (pair of electron-hole) are internally generated in an amount equivalent to the level of the applied radiation. In this manner, the applied radiation ray is converted into charges. The radiation detector 60 may convert a radiation ray indirectly into charges by using a fluorescent material and a photoelectric conversion element (a photodiode), instead of the radiation-charge converting material such as amorphous selenium that converts a radiation ray directly into charges. As for the fluorescent material, gadolinium oxysulfide (GOS) and cesium iodide (CsI) are well known. In this case, a radiation-light conversion is performed with the fluorescent material, and a light-charge conversion is performed with the photodiode of the photoelectric conversion element.

A large number of pixel units 74 (the photoelectric conversion layer corresponding to the respective pixel units 74 being schematically shown as photoelectric conversion units 72 in FIG. 2) each including a storage capacitor 68 that stores charges generated from the photoelectric conversion layer and a TFT 70 for reading the charges stored in the storage capacitor 68 are arranged in a matrix fashion on the TFT active-matrix substrate 66. The charges generated in the photoelectric conversion layer as a result of radiation application to the electronic cassette 32 are stored in the storage capacitors 68 of the respective pixel units 74. With this arrangement, the image information carried by the radiation ray applied onto the electronic cassette 32 is converted into charge information, and is carried by the radiation detector 60.

Also, plural gate interconnects 76 and plural data interconnects 78 are provided on the TFT active-matrix substrate 66. The gate interconnects 76 extend in one direction (the row direction), and switch on and off the TFTs 70 of the respective pixel units 74. The data interconnects 76 extend in a direction perpendicular to the gate interconnects 78, and read the stored charges from the storage capacitors 68 via switched-on TFTs 70. The respective gate interconnects 76 are connected to a gate wire driver 80, and the respective data interconnects 78 are connected to a signal processing unit 82. When charges are stored in the storage capacitors 68 of the respective pixel units 74, the TFTs 70 of the respective pixel units 74 are sequentially switched on by the row by signals supplied from the gate wire driver 80 via the gate interconnects 76. The charges stored in the storage capacitors 68 of the pixel units 74 having the TFTs 70 switched on are transmitted as analog electrical signals through the data interconnects 78, and are then input to the signal processing unit 82. In this manner, the charges stored in the storage capacitor 68 of the respective pixel units 74 are sequentially read out by the row.

The signal processing unit 82 operates under the control of a cassette control unit 92 described later, and detects the amount of charges stored in the storage capacitors 68 of the respective pixel units 74 by the row. The signal processing unit 82 then outputs digital image information.

An image memory 90 is connected to the signal processing unit 82. Image information and error information that are output from the signal processing unit 82 are sequentially stored into the image memory 90. The image memory 90 has such a storage capacity as to store image information about a predetermined number of radiation images. Every time charges of one line are read out, the image information about the read one line is sequentially stored into the image memory 90.

The image memory 90 is connected to the cassette control unit 92 that controls operations of the entire electronic cassette 32. The cassette control unit 92 is realized by a microcomputer, and includes a CPU 92A, a memory 92B containing a ROM and a RAM, and a nonvolatile storage unit 92C formed by a HDD or a flash memory.

A wireless communication unit 94 is connected to the cassette control unit 92. The wireless communication unit 94 complies with wireless LAN (local area network) standards such as IEEE (Institute of Electrical and Electronics Engineers) 802.11a/b/g, and controls transmission of various kinds of information with external devices through wireless communication. The cassette control unit 92 may perform wireless communication with the console 42 via the wireless communication unit 94, and may exchange various kinds of information with the console 42. The cassette control unit 92 stores later described irradiation conditions received from the console 42, and, based on the irradiation conditions, starts the reading of charges.

A power supply unit 96 is also provided in the electronic cassette 32. The above described various circuits and elements (the gate wire driver 80, the signal processing unit 82, the image memory 90, the wireless communication unit 94, and the microcomputer functioning as the cassette control unit 92) are actuated by the power supplied from the power supply unit 96. The power supply unit 96 contains a battery (a rechargeable secondary cell) so as to maintain the portability of the electronic cassette 32, and supplies power from the charged battery to the various circuits and elements. In FIG. 2, the interconnects that connect the power supply unit 96 to the various circuits and elements are not shown.

The console 42 includes a display 100 that displays an operation menu, a captured radiation image, and the like, and an operation input unit 102 that is designed to have plural keys and has various kinds of information and operation instructions input therethrough.

The console 42 further includes: a CPU 104 that controls operations of the entire apparatus; a ROM 106 in which various kinds of programs including a control program are stored in advance; a RAM 108 that temporarily stores various kinds of data; a HDD 110 that stores and holds various kinds of data; a display driver 112 that controls displaying of various kinds of information on the display 100, and receives operation information from the display 100; an operation input detecting unit 114 that detects an operation state of the operation input unit 102; an image signal output unit 210 that outputs image signals to the stereo display device 220; a communication interface unit 116 that is connected to the connecting terminal 42A, and exchanges various kinds of information, such as the irradiation conditions, imaging site information, and the status information about the radiation generator 34, with the radiation generator 34 via the connecting terminal 42A and the communication cable 35; and a wireless communication unit 118 that exchanges various kinds of information such as the irradiation conditions and image information with the electronic cassette 32 through wireless communication.

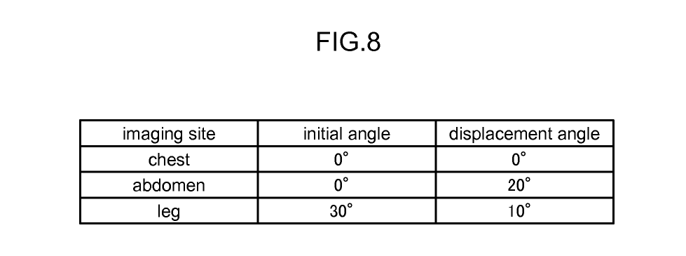

In the HDD 110, the data about the initial angles for capturing the first image, and the data about the displacement angles between the radiation source in the first image capturing operation and the radiation source in the second image capturing operation are associated with respective imaging sites, as shown in FIG. 8.

The CPU 104, the ROM 106, the RAM 108, the HDD 110, the display driver 112, the operation input detecting unit 114, the image signal output unit 210, the communication interface unit 116, and the wireless communication unit 118 are connected to one another via a system bus BUS. Therefore, the CPU 104 may access the ROM 106, the RAM 108, and the HDD 110. Also, the CPU 104 may control the displaying of various kinds of information on the display 100 via the display driver 112, recognize the operation information from the display 100, control the image to be displayed on the stereo display device 220 via the image signal output unit 210, control the exchange of various kinds of information with the radiation generator 34 via the communication interface unit 116, and control the exchange of various kinds of information with the electronic cassette 32 via the wireless communication unit 118. Further, the CPU 104 may recognize the user operation state of the operation input unit 102 via the operation input detecting unit 114.

The radiation generator 34 includes: the radiation source 130 that outputs a radiation ray; the communication interface unit 132 that exchanges various kinds of information, such as the irradiation conditions, the imaging site information, and the status information about the radiation generator 34, with the console 42; the source control unit 134 that controls the radiation source 130, based on the received irradiation conditions; and the source drive control unit 136 that controls operations of the ball screw 147 and the gear 145 by controlling the power supply to the motor (not shown) driving the ball screw 147 and the gear 145.

The source control unit 134 is also realized by a microcomputer, and stores the received irradiation conditions, imaging site information, and the like. The irradiation conditions received from the console 42 contain information such as tube voltage, tube current, and irradiation time. Based on the received irradiation conditions, imaging site information, and the like, the source control unit 134 controls the C-shaped arm 140 by controlling the motor (not shown) driving the gear 145. By doing so, the source control unit 134 adjusts the angle at which the X-ray 131 emitted from the radiation source 130 is incident on the cassette 32 and the object 50. In this manner, the source control unit 134 causes the radiation source 130 to emit the X-ray 131, based on the received irradiation conditions.

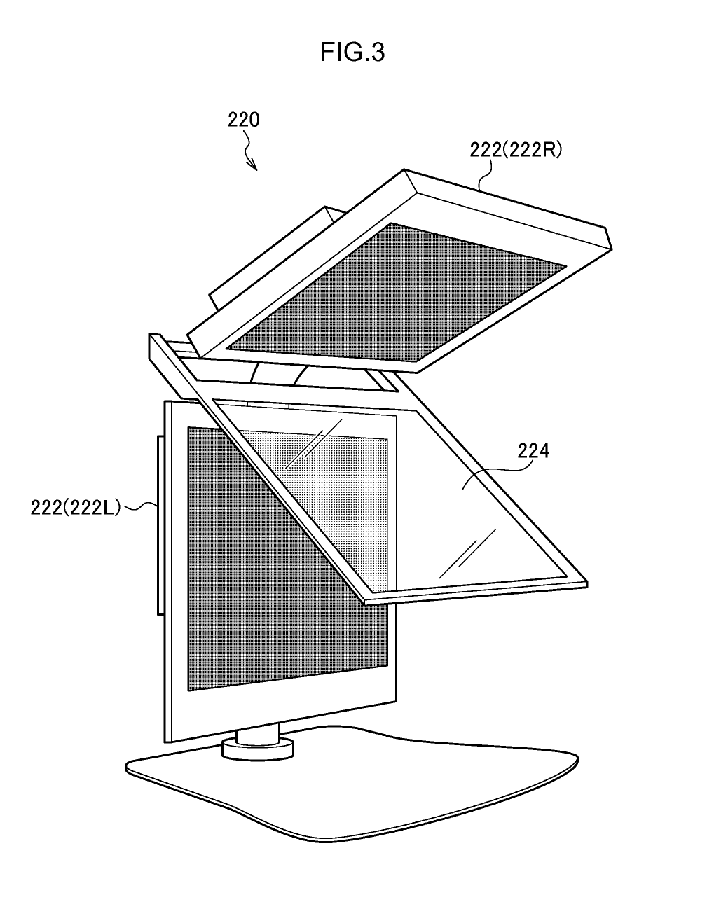

FIG. 3 illustrates an example structure of the stereo display device 220 according to this exemplary embodiment.

As shown in the drawing, in the stereo display device 220, two display units 222 are vertically arranged, and the upper display unit 222 is tilted forward and is fixed. The two display units 222 have display-light polarizing directions perpendicular to each other. The upper display unit 222 is a display unit 222R that displays an image for the right eye, and the lower display unit 222 is a display unit 222L that displays an image for the left eye. A beam splitter mirror 224 that transmits the display light emitted from the display unit 222L and reflects the display light emitted from the display unit 222R is provided between the display units 222L and 222R. The beam splitter mirror 224 is fixed at an angle that is adjusted so that the image displayed on the display unit 222L and the image displayed on the display unit 222R overlap with each other when an observer sees the stereo display device 220 from the front.

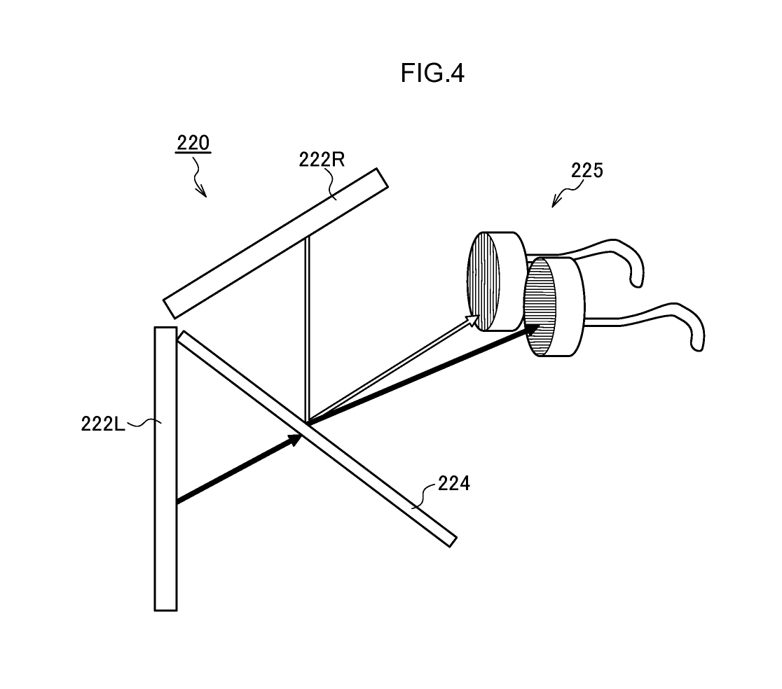

As shown in FIG. 4, by seeing the stereo display device 220 through polarizing glasses 225 formed by a right lens and a left lens that have polarizing directions perpendicular to each other, the observer may view the image displayed on the display unit 222L and the image displayed on the display unit 222R with the right eye and the left eye independently of each other. In this manner, the observer may stereoscopically view an image.

Next, the functions of the radiation image capturing apparatus 10 according to this exemplary embodiment are described.

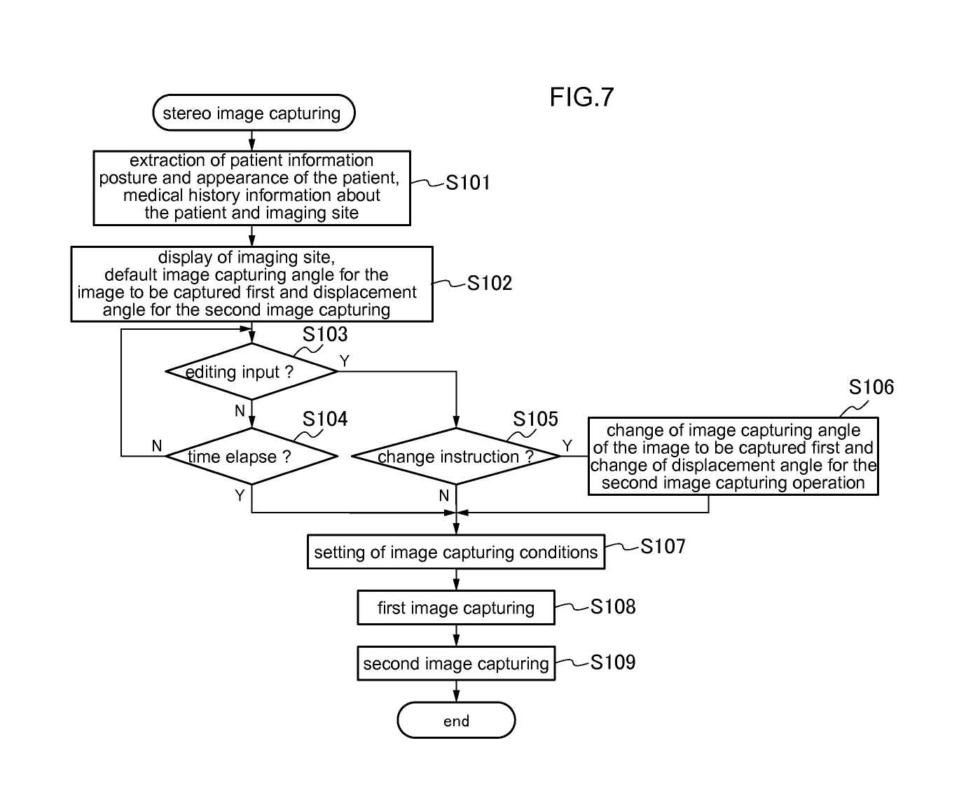

As shown in FIG. 7, information about the patient to be the object 50 is first extracted. The patient information contains information about the posture and appearance of the patient, medical history information about the patient, imaging site information, and the like (S101).

The default data about the initial angle for the first image capturing operation and the default data about the displacement angle between the radiation source in the first image capturing operation and the radiation source in the second image capturing operation, which are associated with the corresponding imaging site and are stored in the HDD 110 as shown in FIG. 8, are displayed as initial image capturing angle information on the display 100 (S102).

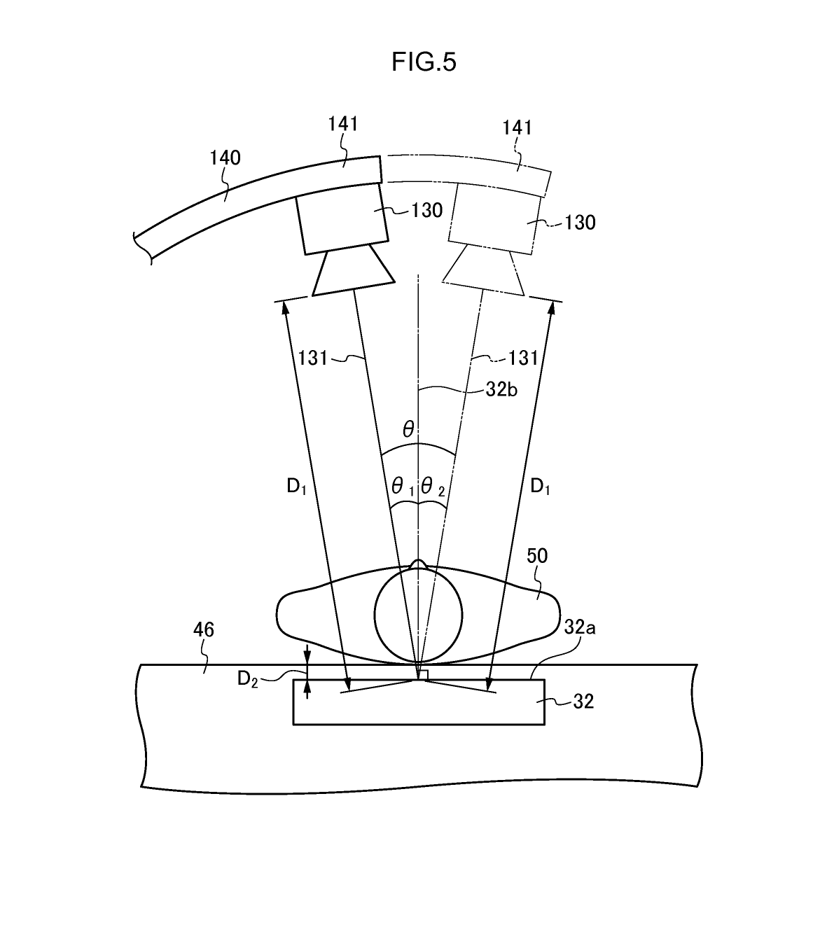

When there is a change in the default value of the initial angle for the first image capturing operation (S105), the image capturing angle of the image to be captured first (θ1: the angle of the radiation source 130 with respect to the direction 32b perpendicular to the surface 32a of the electronic cassette 32, see FIG. 5) is changed (S106). When there is a change in the default value of the displacement angle (θ=θ1+θ2: the parallax difference) of the image capturing angle of the image to be captured second (θ2: the angle of the radiation source 130 with respect to the direction 32b perpendicular to the surface 32a of the electronic cassette 32, see FIG. 5) with respect to the image capturing angle of the image to be captured first (θ1), the displacement angle is changed (S106). After that, the image capturing conditions, other than the image capturing angle of the image to be captured first and the displacement angle for the second image capturing operation, are set (S107).

The displacement angle is an angle at which stereoscopic viewing is readily performed, and is predetermined for each imaging site. A change in the image capturing angle of the image to be captured first and a change in the parallax angle may be made through the operation input unit 102. Such changes may also be made through the display 100, where a touch panel or the like is used as the display 100.

When there is not a change in the default values of the initial angle for the first image capturing operation and the displacement angle (S105), the image capturing conditions, other than the image capturing angle of the image to be captured first and the displacement angle for the second image capturing operation, are set (S107).

After the default data about the initial angle for the first image capturing operation and the default data about the displacement angle between the radiation source in the first image capturing operation and the radiation source in the second image capturing operation are displayed as the initial image capturing angle information on the display 100 (S102), a predetermined period of time might elapse without editing (S103, S104). In such a case, the screen on the display 100 automatically switches to a setting screen for the image capturing conditions other than the image capturing angle of the image to be captured first and the displacement angle for the second image capturing operation (S107).

The image capturing conditions, other than the image capturing angle of the image to be captured first and the displacement angle for the second image capturing operation, are then set in the console 42 through the operation input unit 102 (S107). The image capturing conditions include the information about the electronic cassette 32, the exposure conditions such as tube voltage, tube current, and irradiation time.

The console 42 transmits the input set positional information (the image capturing angle of the image to be captured first and the displacement angle for the second image capturing operation) about the radiation source 130, the information about the electronic cassette 32, the imaging site information, and the like to the radiation generator 34.

The console 42 also transmits image capturing control information, such as the irradiation time during which the radiation generator 34 keeps emitting a radiation ray when a radiation image is to be captured, to the electronic cassette 32 through wireless communication.

The radiation generator 34 adjusts the height of the C-shaped arm 140 so that the height of the center of rotation of the C-shaped arm 140 or the height of the center of rotation of the radiation source 130 becomes equal to the height of the upper surface 32a of the electronic cassette 32.

The radiation generator 34 then rotates the C-shaped arm 140, and positions the radiation source 130 at a predetermined angle θ1 with respect to a direction 32b perpendicular to the surface 32a of the electronic cassette 32, as shown in FIG. 5. The predetermined angle θ1 is the default value when there is not a change in the default value of the initial angle for the first image capturing operation, and is a changed value after the angle θ1 is changed in step S106.

The radiation generator 34 then emits the X-ray 131 from the radiation source 130 under predetermined irradiation conditions. The X-ray 131 emitted from the radiation source 130 carries image information about the object 50 after transmitted through the object 50, and then reaches the electronic cassette 32 serving as a radiation detector.

The X-ray 131 carrying the image information is converted into an electrical signal by the electronic cassette 32, and the electrical signal is stored into the image memory 90.

After the image is captured, the cassette control unit 92 transmits the image information stored in the image memory 90 to the console 42 through wireless communication.

The console 42 performs various kinds of image corrections such as a shading correction on the received first image information, and stores the corrected first image information together with first image capturing information into the HDD 110. The first image capturing information contains the positional information about the radiation source 130 (such as the angle information (θ1) about the radiation source 130 and the distance D1 between the radiation source 130 and the electronic cassette 32), the information about the electronic cassette 32 (such as the distance D2 between the electronic cassette 32 and the object 50, the information as to whether the electronic cassette 32 has a holder, the type of the holder if the electronic cassette 32 has one, and the information as to whether a grid was used), the irradiation conditions such as tube voltage, tube current and irradiation time, the imaging site information and the like.

The electronic cassette 32 performs a reset operation to stand by for the next image capturing operation.

Next, a second image for stereoscopic viewing is captured by changing the position of the radiation source 130 to change a parallax angle. In the case of the second image, the height of the center of rotation of the C-shaped arm 140, or the height of the center of rotation of the radiation source 130 is the same as the height in the case of the first image. The exposure conditions such as tube voltage, tube current, and irradiation time are also the same as those used in the first image capturing operation.

When there is not a change in the default value of the displacement angle (θ: the parallax difference) of the image capturing angle of the image to be captured second (θ2: the angle of the radiation source 130 with respect to the direction 32b perpendicular to the surface 32a of the electronic cassette 32, see FIG. 5) with respect to the image capturing angle of the image to be captured first (θ1), the default value is set as the displacement angle (θ: the parallax difference). After a change is made in step S106, the changed value is set as the displacement angle (θ: the parallax difference).

The console 42 transmits the displacement angle, the exposure conditions such as tube voltage, tube current, and irradiation time, and the like to the radiation generator 34.

The console 42 also transmits image capturing control information, such as the irradiation time during which the radiation generator 34 keeps emitting a radiation ray when a radiation image is to be captured, to the electronic cassette 32 through wireless communication.

The radiation generator 34 then rotates the C-shaped arm 140, and positions the radiation source 130 at a predetermined angle θ2 with respect to the direction 32b perpendicular to the surface 32a of the electronic cassette 32 (or at a displacement angle (parallax angle θ (=θ1+θ2)) with respect to the angle in the case of the first image capturing), as shown in FIG. 5. The distance D1 between the radiation source 130 and the electronic cassette 32 is maintained.

The radiation generator 34 then emits the X-ray 131 from the radiation source 130 under predetermined irradiation conditions. The X-ray 131 emitted from the radiation source 130 carries image information about the object 50 after transmitted through the object 50, and then reaches the electronic cassette 32 serving as a radiation detector.

The X-ray 131 carrying the image information is converted into an electrical signal by the electronic cassette 32, and the electrical signal is stored into the image memory 90.

After the image is captured, the cassette control unit 92 transmits the image information stored in the image memory 90 to the console 42 through wireless communication.

The console 42 performs various kinds of image corrections such as a shading correction on the received second image information, and stores the corrected second image information together with second image capturing information into the HDD 110. The second image capturing information contains the positional information about the radiation source 130 (such as the displacement angle (parallax angle θ) about the radiation source 130 and the distance D1 between the radiation source 130 and the electronic cassette 32), the information about the electronic cassette 32 (such as the distance D2 between the electronic cassette 32 and the object 50, the information as to whether the electronic cassette 32 has a holder, the type of the holder if the electronic cassette 32 has one, and the information as to whether a grid was used), the irradiation conditions such as tube voltage, tube current and irradiation time, the imaging site information, and the like.

At this point, the second image information and image capturing information are stored, together with the first image information and image capturing information, and the parallax difference (θ=θ1+θ2) in the first and second image capturing operations, into the HDD 110. The information is stored as the image information and image capturing information about two stereoscopic viewing images obtained by one image capturing operation.

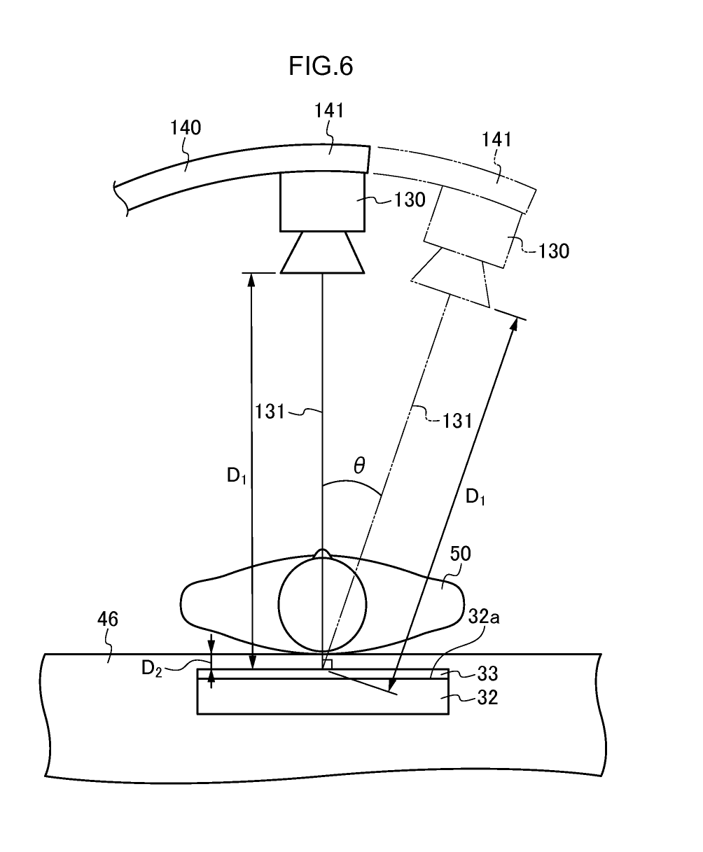

In a case where a grid 33 is used on the electronic cassette 32 as shown in FIG. 6, the first radiation image (a perpendicular image) is obtained by capturing an image from a direction perpendicular to the surface 32a of the electronic cassette 32, and the C-shaped arm 140 is then rotated so that the radiation source 130 is located at a predetermined angle θ with respect to the direction 32b perpendicular to the surface 32a of the electronic cassette 32 (or is located to have the parallax angle θ with respect to the first image capturing operation). After that, the second radiation image is preferably captured. Alternatively, the first image may be captured while the radiation source 130 is located at the predetermined angle θ with respect to the direction 32b perpendicular to the surface 32a of the electronic cassette 32. After that, the second image may be captured from the direction perpendicular to the surface 32a of the electronic cassette 32. In such a case, the settings are changed in step S106 so that the second image is captured from the perpendicular direction. A grid is normally used for some imaging sites, and the angle formed by the perpendicular direction might be set as the default value. In such a case, the imaging site is the chest or abdomen, for example, as shown in FIG. 8.

In such a case, the first image information and image capturing information, the sec and image information and image capturing information, the parallax difference (θ) in the first and second image capturing operations, and the information as to which one of the first and second images is a perpendicular image are stored as the image information and image capturing information about the two stereoscopic viewing images obtained through one image capturing operation, into the HDD 110.

The following is a description of a stereo image forming operation to be performed by the console 42 to cause the stereo display device 220 to display a stereo image based on the two radiation images stored as one piece of image capturing information in the HDD 110.

When a predetermined stereo image display start instruction is issued to the operation input unit 102, the console 42 performs the stereo image forming operation to form an image for the right eye and an image for the left eye that may be stereoscopically viewed, and causes the stereo display device 220 to display a stereo image.

The program for the stereo image forming operation is stored beforehand in a predetermined region in the ROM 106, and is executed by the CPU 104.

The program for the stereo image forming operation is performed to generate three-dimensional information based on the two stored radiation images, form the image for the right eye and the image for the left eye, cause the display unit 222R to display the image for the right eye, and cause the display unit 222L to display the image for the left eye. At this point, the image for the right eye and the image for the left eye are positioned, with a predetermined amount of offset being kept in the horizontal direction.

With this arrangement, an observer such as a physician may stereoscopically interpret radiation images and make a diagnosis from radiation images by viewing the screen of the stereo display device 220 through the polarizing glasses 225.

In this exemplary embodiment, each image capturing site is associated with a default image capturing angle of the radiation image to be first captured, and is stored together with the default image capturing angle. The default image capturing angle associated with the image capturing site is displayed as the initial image capturing angle to be changed, so that the default value may be changed. Therefore, the first image capturing conditions may be set in a simple manner. At home, the patient may not easily move or there is only a limited space. Therefore, the first image capturing conditions are preferably set in a simple manner, to achieve a greater effect.

Also, the displacement angle (the parallax difference) for the second image capturing operation is associated with each imaging site, and is stored. The default displacement angle associated with each imaging site is displayed as the initial displacement angle to be changed, so that the default value may be changed. Therefore, the second image capturing conditions may also be set in a simple manner. The default value of the displacement angle is predetermined for each imaging site, and is an angle at which stereoscopic viewing may be readily performed. Therefore, setting the second image capturing conditions becomes particularly easy.

In the above described exemplary embodiment, the portable electronic cassette 32 is used as a radiation detector. However, instead of the electronic cassette 32, a stationary radiation detector may be used.

In the above described exemplary embodiment, an X-ray is used as a radiation ray. However, the invention is not limited to X-rays, and a y-ray or the like may be used, instead of an X-ray, for example.

Various exemplary embodiments of the invention have hitherto been described, how ever, the invention is not limited to the exemplary embodiments. Therefore, the scope of the invention is limited only by the appended claims.

What is claimed is:

1. A radiation image capturing apparatus comprising:
a storage unit that stores imaging site information associated with default image capturing angle information about a radiation image to be captured first among a plurality of radiation images of an object captured from different angles with a radiation ray emitted from a radiation source;
a radiation source holding unit that holds the radiation source, with an angle of the radiation source being variable;
a display unit that displays the default image capturing angle information associated with the imaging site information, the default image capturing angle information being displayed as initial image capturing angle information and variable information;
a receiving unit that receives change information about the initial image capturing angle information; and
a control unit that controls the radiation source holding unit to change the angle of the radiation source, based on the change information received by the receiving unit.

2. The radiation image capturing apparatus of claim 1, which is of a portable type.

3. The radiation image capturing apparatus of claim 1, wherein the storage unit stores a default value of a displacement angle of a radiation image to be captured second with respect to an image capturing angle of the radiation image captured first, the default value of the displacement angle being associated with the imaging site information.

4. The radiation image capturing apparatus of claim 3, wherein the display unit displays the default displacement angle as an initial displacement angle that is variable,
the receiving unit receives the change information about the initial displacement angle, and
the control unit controls the radiation source holding unit to change the angle of the radiation source, based on the displacement angle change information received by the receiving unit.

5. The radiation image capturing apparatus of claim 3, wherein the displacement angle is predetermined for each imaging site and is an angle at which stereoscopic viewing is readily performed.

6. The radiation image capturing apparatus of claim 1, wherein, after displaying the default image capturing angle information associated with the imaging site information as initial image capturing angle information that is variable, the display unit displays a screen for setting image capturing conditions other than an image capturing angle when the change information about the initial image capturing angle information is not received by the receiving unit within a predetermined period of time.

7. A radiation image capturing method comprising:
causing a display unit to display default image capturing angle information as initial image capturing angle information associated with imaging site information, the default image capturing angle information being about a radiation image to be captured first among a plurality of radiation images of an object captured from different angles with a radiation ray emitted from a radiation source, the imaging site information and the default image capturing angle information being associated with each other and being stored in a storage unit; and
controlling a radiation source holding unit to change an angle of a radiation source, based on change information received by a receiving unit that receives the change information about the initial image capturing angle information, the radiation source holding unit holding the radiation source, with an angle of the radiation source being variable.

8. A non-transitory computer-readable medium storing a program that causes a computer to perform a process including:
causing a display unit to display default image capturing angle information as initial image capturing angle information associated with imaging site information, the default image capturing angle information being about a radiation image to be captured first among a plurality of radiation images of an object captured from different angles with a radiation ray emitted from a radiation source, the imaging site information and the default image capturing angle information being associated with each other and being stored in a storage unit; and
controlling a radiation source holding unit to change an angle of a radiation source, based on change information received by a receiving unit that receives the change information about the initial image capturing angle information, the radiation source holding unit holding the radiation source, with an angle of the radiation source being variable.
